(19) United States
(12) Patent Application Publication
(10) Pub. No.: US 2022/0020279 A1
(43) Pub. Date: Jan. 20, 2022

(54) INFORMATION PROCESSING APPARATUS

(71) Applicant: NTT DOCOMO, INC., Tokyo (JP)

(72) Inventors: Takefumi YAMADA, Tokyo (JP); Yuichiro SEGAWA, Tokyo (JP); Yasuhiro KITAMURA, Tokyo (JP)

(73) Assignee: NTT DOCOMO, INC., Tokyo (JP)

(21) Appl. No.: 17/312,727

(22) PCT Filed: Jan. 14, 2020
(86) PCT No.: PCT/JP2020/000868

§ 371 Date: Jun. 10, 2021

(30) Foreign Application Priority Data
Jan. 22, 2019 (JP) 2019-008383

(51) Int. Cl. G08G 5/04; G08G 5/00

(52) U.S. Cl. CPC G08G 5/045; G08G 5/0069; G08G 5/003; G08G 5/006

(57) ABSTRACT

A flight information acquisition unit periodically acquires flight information (information indicating flight status, including the position and flight direction of the host aerial vehicle) of a drone. A flight irregularity determination unit determines, based on the acquired flight information, whether or not a drone belonging to a group under control of this device is flying with deviation from a flight plan. Based on the flight plans of drones belonging to another group, first collision specification unit specifies a drone at risk of collision with a drone that is performing irregular flight. When the flight status of a drone that is performing irregular flight is acquired, a flight irregularity notification unit gives notification of that flight status to a server associated with a drone specified by a first collision specification unit.

### TECHNICAL FIELD

The present invention relates to a technology for safe flight of an aerial vehicle.

### BACKGROUND ART

Japanese Patent Application No. JP-2017-130121A discloses a technique for, in an aircraft system in which a server collects planned trajectories of each aircraft to avoid a collision, reducing the load of the server by causing each aircraft to generate a self-planned trajectory that does not interfere with the planned trajectories of other aircrafts.

### SUMMARY OF INVENTION

As aerial vehicles such as drones are widely used, conceivable that many businesses that monitor the flight status of aerial vehicles are expected to be established. In that case, it is desirable that flight statuses are shared between businesses. However, if flight statuses for all aerial vehicles are shared, there is a concern that the processing load will increase, and as a result disadvantages due to a delay in processing (such as a delayed response when there is a risk of a drop or the like) will occur.

Accordingly, an object of the present invention is to reduce the processing load of sharing flight statuses of aerial vehicles that belong to different groups.

In one aspect, the present invention provides an information processing apparatus including: a plan acquisition unit configured to acquire flight plans for an aerial vehicle belonging to a first group; a status acquisition unit configured to acquire a flight status of the aerial vehicle; and a notification unit configured to notify a flight status to an external device associated with an aerial vehicle belonging to a second group, when the flight status of the aerial vehicle indicative of deviation from the acquired flight plan is acquired.

According to the present invention, it is possible to reduce the processing load of sharing flight statuses of an aerial vehicles that belong to different groups.

### BRIEF DESCRIPTION OF DRAWINGS

FIG. 1 is a diagram showing an example of the overall configuration of an operation management support system according to the present invention.

FIG. 2 is a diagram showing an example of a hardware configuration of a server and an integrated management device according to the present invention.

FIG. 3 is a diagram showing an example of a hardware configuration of a drone according to the present invention.

FIG. 4 is a diagram showing a functional configuration realized by each device according to the present invention.

FIG. 5 is a diagram showing an example of flight information according to the present invention.

FIGS. 6A and 6B are a diagram showing an example of flight plans according to the present invention.

FIG. 7 is a diagram showing an example of an operation procedure of each device in notification processing according to the present invention.

FIG. 8 is a diagram showing another example of an operation procedure of the server in priority processing according to the present invention.

### DETAILED DESCRIPTION

### 1. Embodiment

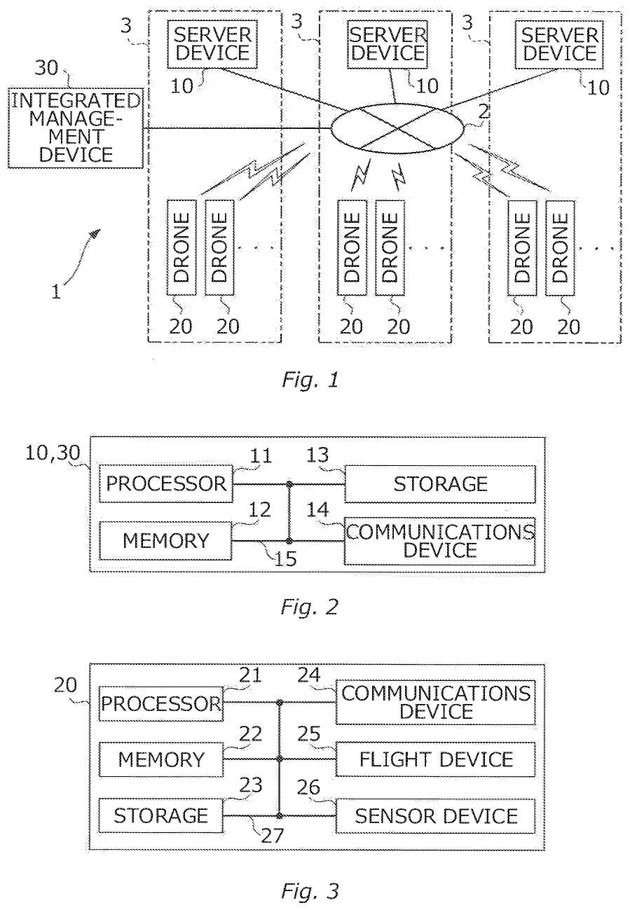

FIG. 1 is a diagram showing an example of the overall configuration of operation management support system 1 according to an embodiment. Operation management support system 1 is a system that supports operation management of aerial vehicle. Operation management refers to managing flight (flight operation) according to a flight plan for an aerial vehicle such as a drone. In the present embodiment, it is assumed that there are a plurality of businesses 3 that perform operation management, and each business 3 manages flight operation of respective aerial vehicles under its control.

Operation management support system 1 includes network 2, a plurality of servers 10, a plurality of drones 20, and integrated management device 30. Network 2 is a communications system including a mobile communications network, the Internet, and the like, and relays the exchange of data between devices that access that system. Network 2 is accessed by servers 10 and integrated management device 30 through wired communications (or wireless communications), and by drones 20 through wireless communication.

In the present embodiment, drones 20 are rotary blade-type aerial vehicle that fly by rotating one or more rotary blades, and are used in various applications such as imaging, inspection, spraying, security, and transportation. Drones 20 fly according to operation by an operator. Operation by the operator is performed by using a ‘propo’ (a controller that performs proportional control), a personal computer for giving flight instructions (a device that continuously outputs flight instructions that have been set), or the like.

Since drones 20 are used in operation management for the purpose of safe flight and the like, information (“flight information”) indicating flight status, including at least a position of an aerial vehicle during flight, is periodically transmitted to server 10 that controls the aerial vehicle. Server 10 is provided by business 3, and performs processing for managing flight of drones 20 under control of business 3 and the device, based on transmitted flight information and the flight plan of each drone 20. Details of this processing will be described later.

Integrated management device 30 collects information (flight plans, flight information, and the like) handled by the plurality of servers 10, and performs processing for smoothly sharing information among the devices and the like. For example, flight plans for drones 20 can be shared more efficiently by being once collected in integrated management device 30 and then distributed to each server 10, rather than sharing the flight plans by servers 10. However, not all information sharing is performed by integrated management device 30. Sharing information performed directly between servers 10 will also be described later in detail.

FIG. 2 is a diagram showing an example of a hardware configuration of server 10 and integrated management device 30. Server 10 and integrated management device 30 may be configured, physically, as computer devices that include processor 11, memory 12, storage 13, communications device 14, bus 15, and the like. Note that in the following description, the term “device” used here can be replaced with “circuit”, “device”, “unit”, or the like.

Also, one or more of each device may be included, and some devices may be omitted. Processor 11 controls the computer as a whole by running an operating system, for example. Processor 11 may be constituted by a central processing unit (CPU) including an interface with peripheral devices, a control device, an arithmetic device, registers, and the like.

For example, a baseband signal processing unit or the like may be realized by processor 11. Also, processor 11 reads a program (program code), a software module, data, and the like into memory 12 from at least one of storage 13 and communications device 14, and executes various processing according to these. A program that causes a computer to execute at least some of the operations described in the above embodiment is used as the program.

Although the various processing described above is described as executed by one processor 11, the various processing may be executed simultaneously or sequentially by two or more processors 11. Processor 11 may be implemented using one or more chips. Note that a program may be transmitted from a network over an electrical communications line. Memory 12 is a computer-readable recording medium.

Memory 12 may be constituted by at least one of ROM (Read Only Memory), EPROM (Erasable Programmable ROM), EEPROM (Electrically Erasable Programmable ROM), RAM (Random Access Memory), and so on, for example. Memory 12 may be called a “register”, “cache”, “main memory” (a main storage device), or the like. Memory 12 can store programs (program code) that can be executed to implement a wireless communications method according to an embodiment of the present disclosure, software modules, and the like.

Storage 13 is a computer-readable recording medium, and for example, may be constituted by at least one of an optical disk such as a CD-ROM (Compact Disc ROM), a hard disk drive, a flexible disk, a magneto-optical disk (for example, a compact disk, a digital versatile disk, or a Blu-ray (registered trademark) disk), a smartcard, flash memory (for example, a card, a stick, or a key drive), a Floppy (registered trademark) disk, a magnetic strip, and the like.

Storage 13 may be called an auxiliary storage device. The above-mentioned storage medium may be a database, a server, or another appropriate medium including memory 12 and/or storage 13, for example. Communications device 14 is hardware for communicating between computers over a wired and/or wireless network (a transmitting/receiving device).

For example, the transmitting/receiving antenna, amplifier unit, transmitting/receiving unit, transmission path interface, and the like mentioned above may be realized by communications device 14. The transmitting/receiving unit may be implemented by physically or logically separating the transmission unit and the receiving unit. Further, each device such as processor 11 and memory 12 is configured to be connected by bus 15 for communicating information. Bus 15 may be configured using a single bus, or may be configured by using a different bus for each device.

FIG. 3 is a diagram showing an example of a hardware configuration of drone 20. Physically, drone 20 may be configured as a computer device including processor 21, memory 22, storage 23, communications device 24, flight device 25, sensor device 26, bus 27, and the like. Among these, hardware having the same name as that shown in FIG. 2 is the same kind of hardware, although having different performance, specifications, and the like.

Communications device 24, in addition to communicating with network 2, has a function of communicating with the propo (for example, a function of wireless communications by radio waves in the 2.4 GHz band). Flight device 25 is a device that includes a motor, a rotor, and the like, and gives drone 20 a capability of flying. Flight device 25 can move drone 20 in any direction in the air, or can make drone 20 stationary (i.e., hovering).

Sensor device 26 is a device having a sensor group that acquires information necessary for flight control. Sensor device 26 includes, for example, a position sensor that measures the position (latitude and longitude) of the host device, a direction sensor that measures the direction the host device is facing (a forward direction is defined for the drone, and the forward direction is the direction the host device is facing), and an altitude sensor that measures the altitude of the host device. Further, sensor device 26 includes a speed sensor that measures the speed of the host device and an inertial measurement sensor (IMU (Inertial Measurement Unit)) that measures the angular velocity on three axes and the acceleration in three directions.

Each function in each device included in operation management support system 1 is realized, by causing predetermined software (programs) to be loaded on hardware such as respective processors and memory, by a processor performing computation to control communications by the respective communications devices, and to control at least one of reading and writing of data in memory and storage.

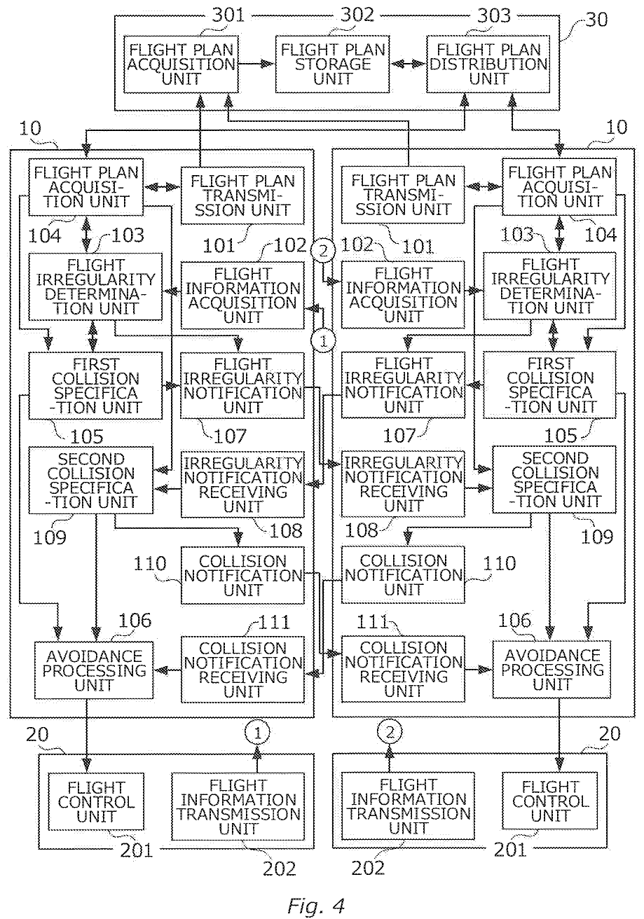

FIG. 4 is a diagram showing a functional configuration realized by each device. In FIG. 4, two combinations of server 10 and drone 20 are shown, and these are combinations of drones 20 under the control of different operation management businesses and servers 10 used to exercise control over drones 20 by the respective operation management businesses. Also, because each server 10 and each drone 20 included in operation management support system 1 have the functions shown in FIG. 4, other servers 10 and drones 20 are not shown.

In operation management support system 1, a device ID that identifies each server 10 and a drone ID that identifies each drone 20 are defined. By assigning those IDs and the current time to data exchanged between devices, the transmission source of information, the target of information (for example, which drone 20 a flight plan belongs to), the transmission time, and the like are identified. Note that although various information such as flight plans and flight information is converted into data and exchanged, in the following description, transmitting data also means simply transmitting information indicated by that data.

Server 10 includes flight plan transmission unit 101, flight information acquisition unit 102, flight irregularity determination unit 103, flight plan acquisition unit 104, first collision specification unit 105, avoidance processing unit 106, flight irregularity notification unit 107, irregularity notification receiving unit 108, second collision specification unit 109, collision notification unit 110, and collision notification receiving unit 111. Each drone 20 includes flight control unit 201 and flight information transmission unit 202. Integrated management device 30 includes flight plan acquisition unit 301, flight plan storage unit 302, and flight plan distribution unit 303.

Flight plan transmission unit 101 of server 10 transmits the flight plan of one or more drones 20 under the control of this server (under the control of the operation management business who uses this server) to integrated management device 30. The flight plan of drone 20 is created by the operation management business having control over drone 20, converted into data, and stored in server 10. The flight plan is, for example, information indicating a flight airspace where drone 20 will fly and a time zone when flight through that flight airspace will occur. The flight plan may be a plan for the current day, or may be a plan for the next day or later. Flight plan transmission unit 101 transmits stored flight plan data to integrated management device 30.

Flight plan acquisition unit 301 of integrated management apparatus 30 acquires the flight plan indicated by the flight plan data, that is, the flight plan of drone 20 to be supported by flight management support system 1. Flight plan acquisition unit 301 supplies the acquired flight plan to flight plan storage unit 302. Flight plan storage unit 302 stores the supplied flight plan in association with a drone ID of drone 20 subject to the plan.

Flight control unit 201 of drone 20 controls flight of that aerial vehicle by using the measurement results of each sensor included in sensor device 26. Flight control unit 201, for example, performs flight control so as to fly on a flight route instructed by an operator using a propo or the like. Flight information transmission unit 202 of drone 20 transmits flight information indicating the flight status of that aerial vehicle to server 10 having control over that aerial vehicle on a regular basis.

Flight information transmission unit 202 generates flight information data based on the measurement results of each sensor included in sensor device 26, and transmits the flight information data to server 10. Flight information acquisition unit 102 of server 10 acquires the flight information transmitted from drone 20 on a regular basis as described above. By acquiring this flight information, flight information acquisition unit 102 acquires the flight status of each of the plurality of drones 20 in flight, which belong to a group under the control of that server. The flight information acquisition unit 102 is an example of a “a status acquisition unit” of the present invention.

Here, for server 10, a group of one or more drones 20 under the control of that server is called a “control group”, and a group of one or more drones 20 under the control of another server 10 (in short, a group different from the control group) is called a “non-control group”. That is, flight information acquisition unit 102 acquires the flight status of one or more drones 20 belonging to the control group. Jurisdiction group is an example of a “first group” of the present invention.

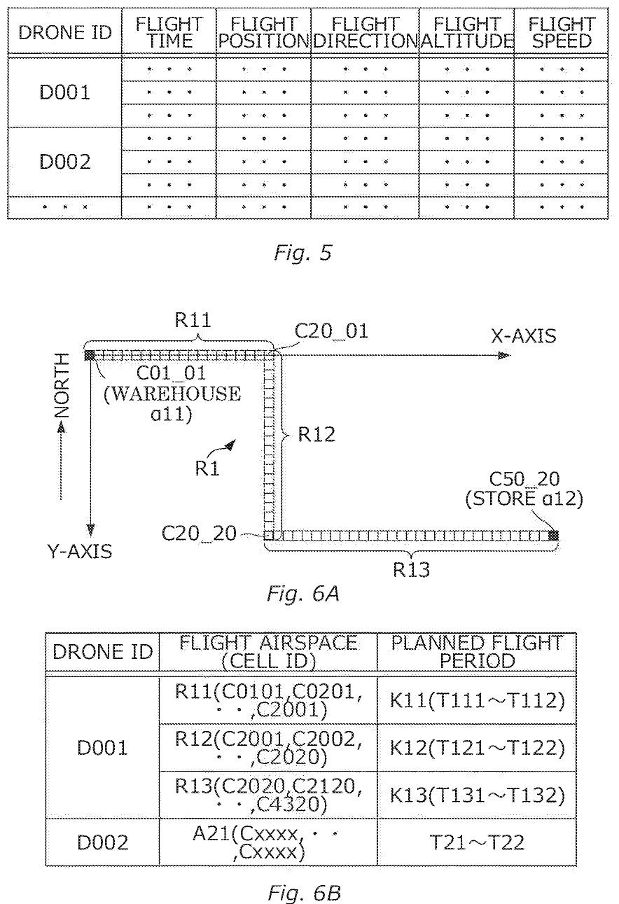

FIG. 5 is a diagram showing an example of flight information. The example in FIG. 5 shows flight information that includes a drone ID, flight time (measurement time of each item of information), flight position (for example, latitude and longitude), flight direction (for example, a numerical value indicating the direction in 360 degrees), flight altitude (for example, the altitude above sea level) and flight speed. Since the flight information is repeatedly acquired, a plurality of flight times and the like are associated with one drone ID.

Flight information acquisition unit 102 supplies the acquired flight information of drone 20 belonging to the control group to flight irregularity determination unit 103. Flight irregularity determination unit 103 determines whether or not drone 20 belonging to the control group is flying with deviation from the flight plan. Flight irregularity determination unit 103 requests from flight plan acquisition unit 104, for example, at the beginning of the day, the flight plans of all drones 20 planned to fly on that day and belonging to the control group.

Flight plan acquisition unit 104 acquires the requested flight plans, that is, the flight plans of drones 20 planned to fly on that day and belonging to the control group. The flight plan acquisition unit 104 is an example of a “plan acquisition unit” of the present invention. Flight plan acquisition unit 104 acquires the requested flight plans by reading the corresponding flight plans from flight plan transmission unit 101 of that server. Flight plans will be described with reference to FIG. 6.

FIG. 6 shows an example of flight plans. In FIG. 6A, the flight airspace where drone 20 with the drone ID “D001” is planned to fly is shown. In operation management support system 1, the flyable airspace where drones 20 can fly is predetermined like a road network. Flyable airspace is airspace for which the necessary permission for flight has been received, and in some cases may include airspace that does not require permission.

In the present embodiment, the flyable airspace is represented by a cubic space (hereinafter referred to as a “cell”) that is spread without any gaps, and each cell is provided with a cell ID that identifies each cell. In the present embodiment, for ease of understanding, the altitude of each cell is constant, and the x-y coordinates of each cell and the cell ID are shown associated with each other (for example, a cell whose x-y coordinates are (x10, y15) is given a cell ID of C10_15).

FIG. 6A shows flight airspace R1 spanning from “warehouse α11” to “store α12”. Flight airspace R1 includes: divided airspace (airspace obtained by dividing the flight airspace) R11 from cell C01_01, which is the departure point of drone 20, through the cells adjacent in the x axis positive direction, and to cell C20_01; divided airspace R12 from cell C20_01, through the adjacent cells in the y axis positive direction, and to cell C20_20; and divided airspace R13 from cell C20_20, through the adjacent cells in the x axis positive direction, and to cell C50_20, which is the destination cell.

FIG. 6B shows, as the flight plan of drone 20 having drone ID “D001”, a cell ID indicating the flight airspace, and a planned flight period in that flight airspace. For example, in the case of above-mentioned drone 20, a cell ID and a planned flight period are shown for each divided airspace. For example, for divided airspace R11, period K11 from planned time T111 to enter divided airspace R11 until planned time T112 to leave divided airspace R11 is shown.

Also, a flight plan for flying in flight airspace A21 from time T21 to T22 is shown for drone 20 having drone ID “D002”. This drone 20 will, for example, photograph a certain site from above, and flight airspace A21 is represented by a set of cell IDs of cells located above that site. In this example, what sort of route to fly in flight airspace A21 is not decided by the plan, but the flight plan may be decided in detail so as to also include what sort of route to fly.

Flight plan acquisition unit 104 supplies the acquired flight plan of drone 20 belonging to the control group to flight irregularity determination unit 103. Flight irregularity determination unit 103 compares the supplied flight plan with the flight status indicated by the supplied flight information, and for example in a case where that drone 20 flies at a position separated by at least a predetermined distance from the flight route planned in the flight plan, determines that drone 20 is flying with deviation from the flight plan. Flight irregularity determination unit 103 determines that drone 20 is flying with deviation from the flight plan, for example, when drone 20 is separated from the flight airspace indicated by the flight plan by two cells or more.

Also, flight irregularity determination unit 103 determines that drone 20 is flying with deviation from the flight plan in a case where although drone 20 is flying on the flight route planned in the flight plan, drone 20 is flying at a time separated by at least a predetermined time interval from the planned flight time zone. Flight irregularity determination unit 103 determines that drone 20 is flying with deviation from the flight plan, for example, when drone 20 is separated from the planned flight period indicated by the flight plan by five minutes or more. Note that the above-described distance of two cells and the above-described time interval of five minutes are examples, and other distances and time intervals may be used.

Here, in this embodiment, as shown in FIG. 1, each server 10 has a group to which drone 20 belongs. Flight plan acquisition unit 104 acquires not only the flight plan of drones 20 belonging to the control group under the control of that server, but also the flight plan of drones 20 belonging to a non-control group under the control of another server 10 and planned to fly that day. Flight plan acquisition unit 104 transmits, to integrated management device 30, request data that requests the flight plan of drones 20 that belong to a relevant non-control group.

Flight plan distribution unit 303 of integrated management device 30 reads out the flight plan requested by the transmitted request data from flight plan storage unit 302 and distributes this flight plan to the requesting server 10. Flight plan acquisition unit 104 acquires the distributed flight plan as the flight plan of drone 20 belonging to the non-control group, and supplies this flight plan to first collision identification unit 105. Note that flight plan acquisition unit 104 also may directly acquire the flight plan of drone 20 belonging to the non-control group from another server 10.

Flight irregularity determination unit 103 supplies flight information of drone 20 that is determined to be flying with deviation from the flight plan to first collision specification unit 105. In a case where flight information has been supplied from flight irregularity determining unit 103, that is, when the flight status of drone 20 indicating deviation from the flight plan has been acquired, first collision specification unit 105 specifies, from among drones 20 belonging to the control group, drone 20 at risk of collision with drone 20 whose flight status indicates deviation from the flight plan.

First collision specification unit 105, for example, specifies drone 20 at risk of collision based on the flight plan of drone 20 belonging to the control group acquired by flight plan acquisition unit 104. In the following description, when simply stating “drone 20 at risk of collision”, this means drone 20 at risk of collision with drone 20 that is performing irregular flight.

Note that when two or more drones 20 are performing irregular flight, it is possible that drone 20 at risk of collision is itself performing irregular flight. Also, in the above example drone 20 that is performing irregular flight and drone 20 at risk of collision both belong to the control group, but there may also be cases where these belong to a non-control group (this case will be described later).

First collision specification unit 105, for example, specifies drone 20 at risk of collision based on the distance between the position of drone 20 included in the supplied flight status (drone 20 that is performing irregular flight) and the current position of drone 20 in the acquired flight plan. Commonly, when the flying positions of two drones approach a certain distance or more, the possibility of collision increases. Therefore, first collision specification unit 105 specifies drone 20 whose distance from drone 20 that is performing irregular flight is less than a threshold value as drone 20 at risk of collision.

Here, “at risk of collision” means a state in which the possibility of collision has increased to at least a predetermined level. For example, even in a state where drones are 100 meters or more apart from each other, the possibility of collision is not zero if they continue to fly, but the possibility is extremely small, so it is not determined that there is a risk of collision. On the other hand, when the distance between the drones approaches a certain distance (a distance less than the above-mentioned threshold value), the possibility of collision certainly increases, depending on the flight direction and the flight speed. Therefore, in such a case, first collision specification unit 105 specifies drone 20 at risk of collision.

When first collision specification unit 105 specifies drone 20 at risk of collision, first collision specification unit 105 notifies avoidance processing unit 106 of the specified drone 20 and drone 20 that is performing irregular flight. When drone 20 belonging to the control group has been specified as at risk of collision, avoidance processing unit 106 performs processing (avoidance processing) for avoiding that collision. The avoidance processing unit 106 is an example of a “processing unit” of the present invention.

As the avoidance processing, for example, avoidance processing unit 106 performs processing that instructs drone 20 at risk of collision with drone 20 that is performing irregular flight to stop for a certain time interval. Also, as the avoidance processing, avoidance processing unit 106 performs processing that instructs to change the flight route of drone 20 to a flight route that allows a collision to be avoided. If drone 20 that is performing irregular flight is drone 20 that belongs to the control group, as the avoidance processing, avoidance processing unit 106 may also perform processing that gives the same instruction to drone 20 that is performing irregular flight.

Avoidance processing unit 106 transmits instruction data indicating the instruction to, for example, drone 20 that is the instruction target. When receiving the instruction data, flight control unit 201 of drone 20 that is the instruction target controls flight of that aerial vehicle according to the instructions indicated by the instruction data. Note that the transmission destination (output destination) of the instruction data is not limited to drone 20, and may be, for example, a propo or personal computer or the like used by an operator. In that case, a propo, a personal computer, or the like displays the instructions indicated by the instruction data, and the operator views this display and performs flight control according to the instructions.

By performing the avoidance processing in this manner, it is possible to prevent drone 20 that is performing irregular flight from colliding with drone 20 belonging to the same control group. Also, first collision specification unit 105, from among drones 20 belonging to non-control groups, specifies drone 20 at risk of collision with drone 20 that is performing irregular flight based on the flight plans of drones 20 belonging to the non-control groups acquired by flight plan acquisition unit 104.

First collision specification unit 105 in this case is an example of a “first specification unit” of the present invention. First collision specification unit 105, for example, with the same method as in the case where drone 20 belonging to the control group is the target (a method using the distance between drones 20), specifies drone 20 at risk of collision using drones 20 belonging to non-control groups as the target.

First collision specification unit 105 gives notification to avoidance processing unit 106 also in a case where drone 20 belonging to a non-control group is specified as drone 20 at risk of collision. Since avoidance processing unit 106 cannot instruct drone 20 belonging to a non-control group, avoidance processing unit 106 performs avoidance processing that instructs drone 20 that is performing irregular flight (that is, drone 20 belonging to the control group) to perform at least one of the above-described stoppage or changing of the flight route.

Flight irregularity determination unit 103 also supplies flight information of drone 20 that is performing irregular flight to flight irregularity notification unit 107. Flight irregularity notification unit 107 transmits the supplied flight information to all the other servers 10, and thus notification of the flight status of drone 20 that is performing irregular flight indicated by the transmitted flight information is given to all other servers 10. Flight irregularity notification unit 107 is an example of a “notification unit” of the present invention, and the group under the control of each of all the other servers 10 is an example of a “second group” of the present invention.

Next is a description of functions of server 10 that receives notification of the flight status. Irregularity notification receiving unit 108 of server 10 that is the notification destination, by receiving the transmitted flight information, receives notification of the flight status of drone 20 that is performing irregular flight. Irregularity notification receiving unit 108 supplies the flight information received as notification of the flight status to second collision specification unit 109 of that server.

When notification of the flight status of drone 20 that is performing irregular flight is received from another server 10, second collision specification unit 109 specifies drone 20 at risk of collision with drone 20 indicated in the notification and belonging to the group under the control of that server. Second collision specification unit 109 is an example of a “second specification unit” of the present invention. Flight plan acquisition unit 104 of that server supplies, among the acquired flight plans, the flight plan of drone 20 belonging to the group under the control of that server to second collision specification unit 109.

Second collision specification unit 109, based on the supplied flight information and flight plan, for example, with the same method as first collision specification unit 105 (a method using the distance between drones 20), specifies drone 20 at risk of collision, using drone 20 that is performing irregular flight indicated in the notification and drone 20 belonging to the control group as the target.

When second collision specification unit 109 specifies drone 20 at risk of collision from drones 20 belonging to the control group, notification of the specified drone 20 is given to avoidance processing unit 106 of that server. When avoidance processing unit 106 receives notification of drone 20 at risk of collision, avoidance processing unit 106 performs the avoidance processing. The avoidance processing performed by avoidance processing unit 106 is the same as the above-described avoidance processing (stop instruction, flight route change instruction, and the like). Second collision specification unit 109 gives notification of the specified drone 20 and drone 20 that is performing irregular flight to collision notification unit 110.

When notification of drone 20 that is performing irregular flight is received, that is, when drone 20 at risk of collision and belonging to the control group has been specified by second collision specification unit 109, collision notification unit 110 gives notification of specified drone 20 to server 10 that is the notification source of the flight status indicating deviation from the flight plan. Collision notification unit 110 is an example of the “notification unit” of the present invention. Collision notification unit 110 performs the above notification by transmitting the flight information indicating the flight status of the specified drone 20 to the above-described server 10 that is the notification source.

Next is a return to description of server apparatus 10 that is the notification source of the flight information that indicates the flight status of drone 20 that is performing irregular flight. Collision notification receiving unit 111 of server 10 that is the notification source receives the transmitted flight information, and thus receives notification of the flight status of drone 20 that is performing irregular flight (drone 20 belonging to the control group) and drone 20 at risk of collision (drone 20 belonging to a non-control group).

Collision notification receiving unit 111 supplies the flight information received as the flight status notification to avoidance processing unit 106. The supplied flight information indicates that there is a possibility of collision with drone 20 belonging to a non-control group in a case where drone 20 belong to the control group is performing irregular flight. Drone 20 belonging to a non-control group may be specified also by first collision specification unit 105 as drone 20 at risk of collision, but this specification is not necessarily performed.

For example, in a case where the flight plan of drone 20 belonging to a non-control group is changed on the same day and the changed flight plan has not been distributed, first collision specification unit 105 uses the old flight plan therefore it is not possible to correctly specify drone 20 at risk of collision. In this case, server 10 that has control over drone 20 whose flight plan has been changed on that day can acquire a new flight plan, and thus it is possible to correctly specify drone 20 at risk of collision.

Therefore, when notification of the flight status of drone 20 at risk of collision with drone 20 belonging to the control group is given from another server 10, even if drone 20 at risk of collision has been specified by first collision specification unit 105, avoidance processing unit 106 performs avoidance processing of drone 20 (drone 20 belonging to the control group and performing irregular flight) at risk of collision with drone 20 (drone 20 belonging to a non-control group) having the flight status for which notification has been given. By performing this avoidance processing, it is possible to prevent a collision from occurring because it is not possible to correctly specify drone 20 at risk of collision for the reasons described above.

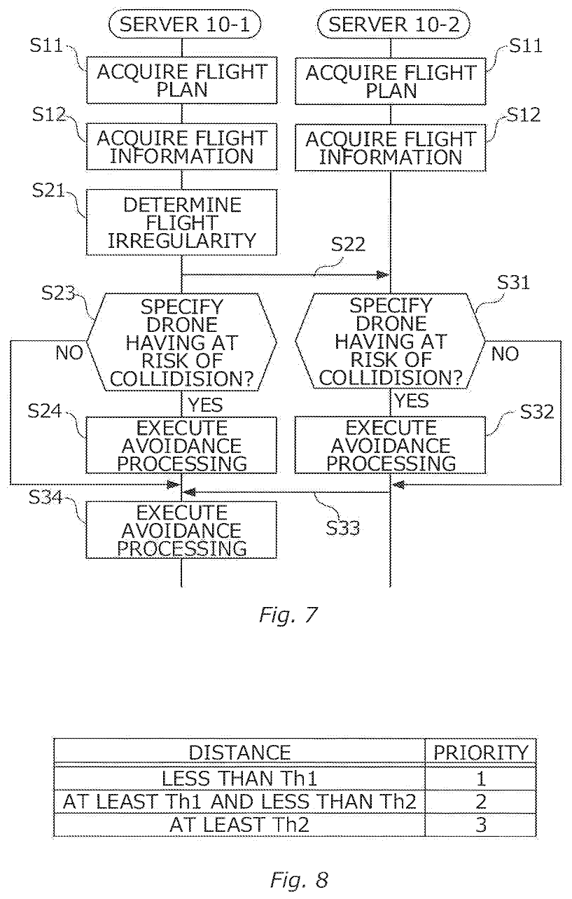

Each device included in operation management support system 1, based on the above configuration, performs notification processing to give notification of the flight status of drone 20 that is performing irregular flight. FIG. 7 shows an example of an operation procedure of each device in notification processing. This operation procedure is started, for example, when a determined time comes every day. Note that, in FIG. 7, for convenience of description, a server where drone 20 that is performing irregular flight is determined is shown as server 10-1, and a server having control over drone 20 at risk of collision is shown as server 10-2.

First, servers 10-1 and 10-2 (flight plan acquisition unit 301) acquire the flight plans of all drones 20 planned to fly on that day (step S11). Next, servers 10-1 and 10-2 (flight information acquisition unit 102) acquire the flight information periodically transmitted from drone 20 under their control (step S12). The operation of step S12 is repeatedly performed.

In the example shown in FIG. 5, at a certain timing, server 10-1 (flight irregularity determination unit 103) determines that drone 20 belonging to the control group is flying with deviation from the flight plan (step S21). Next, server 10-1 (flight irregularity notification unit 107) gives notification of the flight status of drone 20 determined to be performing irregular flight to all servers 10, including server 10-2 (Step S22).

Next, server 10-1 (first collision specification unit 105) determines whether or not drone 20 at risk of collision with drone 20 that is performing irregular flight has been specified (step S23). When determined in step S23 that drone 20 at risk of collision has been specified (YES), server 10-1 (avoidance processing unit 106) performs avoidance processing for avoiding that collision (step S24).

When the flight status notification is received in step S22, server 10-2 (irregularity notification receiving unit 108 and second collision specification unit 109) determines whether or not drone 20 belonging to the control group of that device and at risk of collision with drone 20 having that flight status (drone 20 that is performing irregular flight) has been specified (step S31). When not determined in step S31 that drone 20 at risk of collision has been specified (NO), server 10-2 ends the operation.

When determined in step S31 that drone 20 at risk of collision has been specified (YES), server 10-2 (avoidance processing unit 106) performs avoidance processing for avoiding that collision (step S32). Then, server 10-2 (collision notification unit 110) gives notification of the flight status of the specified drone 20 to server 10-1 that is the notification source of the flight status of drone 20 that is performing irregular flight (step S33).

When the notification is received in step S33, server 10-1 (collision notification receiving unit 111 and avoidance processing unit 106), in order to avoid a collision, performs avoidance processing regarding drone 20 at risk of collision (drone 20 belonging to the control group and that is performing irregular flight) with drone 20 for which notification of the flight status has been given (drone 20 belonging to the control group) (step S34). The operation of step S34 is also performed when not determined that drone 20 at risk of collision with drone 20 that is performing irregular flight has been specified in step S22 (NO).

If the flight statuses of drones 20 respectively under the control of a plurality of businesses are shared among respective servers 10, the load of communications processing, processing to specify drones 20 at risk of collision (specification processing), and the like becomes very high. Compared with such a case, in the present embodiment, flight status notification is given only when irregular flight is performed as described above, and therefore it is possible to reduce the load of processing to share the flight status of drones 20 belonging to different groups (such as communications processing) and processing caused by sharing the flight status (such as specification processing).

Also, in the present embodiment, also in server 10 that received notification of the flight status of drone 20 that is performing irregular flight, when drone 20 at risk of collision is specified, notification of the flight status of the specified drone 20 is given to server 10 that is the notification source. By this notification, so-called double specification is performed by two servers, so even if one server 10 does not correctly specify drone 20 at risk of collision, the other server 10 performs that specification, and therefore the possibility of avoiding a collision can be increased.

Note that, in order to allow this double specification to effectively work, when notification of flight status is given regarding drone 20 at risk of collision, server 10 performs the avoidance processing even when that server did not specify that drone 20 as drone 20 at risk of collision.

### 2. Modifications

The above-described embodiment is merely an example of implementation of the present invention, and may be modified as follows. In addition, the embodiments and the respective modifications may be combined as needed. In that case, the invention may be implemented by assigning a priority rank to each modification (by assigning a priority rank that decides which modification will be given priority when an event occurs that competes with each modification).

### 2-1. Drone Specification Method

First collision specification unit 105 and second collision specification unit 109 may specify drones 20 at risk of collision by a method different from that of the embodiment. For example, in the embodiment, when the distance between the position of drone 20 that is performing irregular flight and the current position of drone 20 in the flight plan is less than a threshold value, first collision specification unit 105 specifies this as drone 20 at risk of collision.

For example, first collision specification unit 105 may change the threshold value according to the positional relationship between drone 20 that is performing irregular flight and other drones 20, and the flight direction. Specifically, first collision specification unit 105 decreases the threshold value when the positions of both drones 20 are approaching each other, and increases the threshold value when the positions of both drones 20 are moving away from each other. Further, when the flight airspace is represented by cells as in the embodiment, the cells may be utilized for performing specification.

For example, a configuration may be adopted in which first collision specification unit 105 predicts a flight path for a certain period in the future from the flight direction of drone 20 that is performing irregular flight, and drone 20 with planned flight through a cell where the distance from drone 20 that is performing irregular flight is less than the threshold value in that period is specified as drone 20 at risk of collision. Also, for example, a cell including a position in three-dimensional space indicated by the flight position and flight altitude included in the flight status of drone 20 indicates in-flight airspace of that drone 20.

Therefore, drone 20 regarding which a flight plan has been acquired to fly through airspace having a predetermined relationship with the airspace in which drone 20 that is performing irregular flight is currently flying may be specified as drone 20 at risk of collision by first collision specification unit 105. The predetermined relationship is, for example, a relationship with the same airspace as the current in-flight airspace. This is because drones 20 flying in the same airspace is at risk of collision with each other.

Note that, in addition, for example, a relationship with the same airspace as the current in-flight airspace of drone 20 that is performing irregular flight or airspace adjacent thereto may be used as the predetermined relationship. Also, when the flight direction of drone 20 is limited, such as in a flight path for transportation, airspaces adjacent to each other only toward the front or rear in the flight direction may be included in the airspaces having a predetermined relationship. By performing specification based on the cells (flight airspaces) in this way, processing to calculate the distance between drones 20 becomes unnecessary.

It is easier to reduce the processing load by determining whether or not coordinates are included in a cell (whether or not coordinates are within a predetermined range) than by calculating the distance between three-dimensional coordinates. Therefore, according to the present modification, the processing load when specifying drone 20 at risk of collision can be reduced compared to a case where specification is based on the distance between drones 20.

On the other hand, although the possibility of collision varies depending on where in a cell an aerial vehicle flies, a detailed collision possibility cannot be determined on a cell-by-cell basis. When the distance between drones 20 is used as in the embodiment, drone 20 at risk of collision can be specified with higher accuracy than in a case where the possibility of collision is determined on a cell-by-cell basis.

Also, second collision specification unit 109 may use the same specification method as first collision specification unit 105 described above. For example, when notification has been given of the flight status of drone 20 performing irregular flight and belonging to a non-control group, as drone 20 at risk of collision, second collision specification unit 109 specifies drone 20 belonging to an interval group for which a flight plan has been acquired to fly through airspace having a predetermined relationship with the in-flight airspace of that drone 20 performing irregular flight.

The concept of the predetermined relationship is as described above. In this case as well, the processing (specification processing) load when specifying drone 20 at risk of collision can be reduced compared to a case where specification is based on the distance between drones 20. Also, when the distance between drones 20 is used as in the embodiment, drone 20 at risk of collision can be specified with higher accuracy than in a case where the possibility of collision is determined on a cell-by-cell basis.

Also, other than the method described above, first collision specification unit 105 and second collision specification unit 109 may, for example, specify drones 20 at risk of collision based on the flight direction or the flight speed of drones 20. In this case, for example, even if the distance between drones 20 is the same, if their flight directions are directed towards each other, there is a higher possibility of collision than if their flight directions are directed away from each other, so such drones 20 are specified as at risk of collision.

Specifically, for example, first collision specification unit 105 specifies drone 20 at risk of collision by setting the threshold value of the distance between drones 20 whose flight directions are directed towards each other (a distance of less than the threshold value indicates that there is a risk of collision) to larger than the threshold value of the distance between drones 20 whose flight directions are directed away from each other. Also, first collision specification unit 105 increases the threshold value of the distance between drones 20 as the flight speed increases. Second collision specification unit 109 can specify drone 20 at risk of collision by a similar method. In both cases, the accuracy of specifying drone 20 at risk of collision can be improved in comparison to a case where the flight direction or the flight speed is not used.

### 2-2. Subject of Notification

In the embodiment, collision notification unit 110 gives notification of the flight status regarding only drone 20 (drone 20 belonging to the control group) specified by second collision specification unit 109 upon receipt of notification of the flight status of drone 20 that is performing irregular flight from another server 10, but the present invention is not limited to this.

For example, in the embodiment, the results of specification by first collision specification unit 105 are used only to narrow down the destination for notification (the destination for notification of the flight status of drone 20 belonging to the control group and performing irregular flight) by flight irregularity notification unit 107. Therefore, when first collision specification unit 105 has specified drone 20 belonging to a non-control group as drone 20 at risk of collision, collision notification unit 110 may also give notification of the flight status of specified drone 20.

By performing this notification, for example, in server 10 that is the destination of notification by flight irregularity notification unit 107, in a case where second collision specification unit 109 could not specify that there is a possibility of collision regarding drone 20 that actually does have a possibility of collision, if first collision specification unit 105 has specified that drone 20, avoidance processing will be performed. In this modification, by such double specification, it is possible to increase the possibility of avoiding even an unlikely collision in comparison to a case where the above notification is not performed.

### 2-3. Priority of Notification

When many drones 20 are flying, there are cases where several drones 20 at risk of collision are specified at the same time. When a plurality of drones 20 at risk of collision are specified in this way, collision notification unit 110 may perform notification by giving priority to server 10 associated with drone 20 having a higher possibility of collision.

For example, in a case where drone 20 at risk of collision has been specified based on the distance between drones 20, the possibility of collision increases as that distance decreases. Therefore, when giving notification of the specified drone 20 to collision notification unit 110, second collision specification unit 109 also includes in the notification the distance between drones 20 used for the specification. Collision notification unit 110 uses, for example, a priority table in which distances between drones 20 and priorities are associated with each other.

FIG. 8 shows an example of a priority table. In FIG. 8, distances, namely “less than Th1”, “at least Th1 and less than Th2”, and “at least Th2”, and priorities of “1”, “2”, and “3” are associated with each other. For example, collision notification unit 110 determines, in each instance of a predetermined period, whether or not there is a notification regarding drone 20 at risk of collision, and when determined that there is a notification, collision notification unit 110 notifies server 10. This period is referred to as a “notification determination period”.

When a plurality of notifications are performed in the same notification determination period, collision notification unit 110 refers to the priorities included in the notifications and associated with the distances, and performs notification beginning from server 10 associated with drone 20 having the higher priority. Note that in a case where there are drones 20 having the same priority, notification by collision notification unit 110 is first given to server 10 associated with drone 20 having the earlier time of notification.

Note that the priority described in this modification may be used by collision notification unit 110 not only when giving notification of the results of specification by second collision specification unit 109, but also when giving notification of the results of specification by first collision specification unit 105. In either case, in this modification, notification is given earlier and avoidance processing is performed earlier regarding drone 20 having a higher possibility of collision, so in comparison with a case where priority is not used, it is possible to increase the possibility of avoiding a collision.

### 2-4. Flight Information

The flight status indicated by the flight information transmitted by drone 20 may be different from that in the embodiment. For example, the flight time does not have to be included in the flight information if real-time processing can be executed and a delay due to communications or the like does not become a problem.

Also, since the flight direction and the flight speed can be calculated from the amount of change of the flight position and the flight altitude, the flight information does not have to include the flight direction and the flight speed. Further, for example, if it is decided to fly at a certain flight altitude in a certain area, the flight information does not need to include the flight altitude. In other words, any information may be included in the flight information as long as the determination of the flight irregularity and the determination of the possibility of the collision between drones 20 are possible.

### 2-5. Narrowing Down Notification Destinations

In the embodiment, flight irregularity notification unit 107 gives notification of the flight status of drones 20 performing irregular flight to all other servers 10, but the notification destinations may be narrowed down. Flight irregularity notification unit 107, for example, may narrow down the notification destinations to only servers 10 that have control over drone 20 that is performing irregular flight and drone 20 that is specified by first collision specification unit 105 as at risk of collision. In this case, the group to which specified drone 20 belongs is an example of the “second group” of the present invention. By doing so, it is possible to reduce the load of processing (communications processing, specification processing, and the like) generated by giving notification of drone 20 that is performing irregular flight, as compared to a case where no narrowing is performed.

### 2-6. Flight Plans

The method of expressing flight plans may be different from that in the embodiment. For example, a flight plan may be expressed using coordinates in a three-dimensional space without using cells. In that case, for example, in a three-dimensional coordinate system, a mathematical expression expressing the flight path as a line, a mathematical expression expressing a boundary plane of the flight airspace, or the like may be used. In addition, a flight plan may be represented only by information regarding a departure point, waypoints, and an arrival point, instead of the route along the way. Even in that case, if it is decided to move along a straight line between each position or to move along a predetermined route, it is possible to determine the route of actual flight.

Also, although it is desirable that a detailed flight period is known for the planned flight period, it may be sufficient to know only the planned departure time and the planned arrival time, for example. In that case as well, for example, by calculating the average flight speed, it is possible to determine the time and area in which flight will occur. In other words, the flight plan may be expressed in any form as long as it is possible to determine irregularity of flight by matching the flight plan with flight information.

### 2-7. Aerial vehicle

In the embodiment, a rotary blade-type aircraft is used as a aircraft that performs autonomous flight, but this is not a limitation. For example, the aircraft may be an aircraft such as an aerial vehicle or a helicopter. In other words, any aircraft that can fly by operation by an operator and has a function of acquiring inspection data may be used.

### 2-8. Devices Realizing Each Function

The devices realizing each function shown in FIG. 4 are not limited to the above-described devices. For example, integrated management device 30, or another external device may realize some of the functions realized by server 10. In other words, it is sufficient that each function shown in FIG. 4 is realized in the operation management support system 1 as a whole.

### 2-9. Category of the Invention

The present invention may be understood as, other than information processing apparatuses of above server 10 and integrated management device 30, an information processing system (operation management support system 1) including those information processing apparatuses and aerial vehicle such as drone 20. The present invention can also be understood as an information processing method for realizing the processing implemented by those information processing apparatuses, or as a program for causing a computer to control those information processing apparatuses. The program may be provided in the form of a recording medium such as an optical disk where the program is stored, or may be provided by being downloaded to a computer over a network such as the Internet and installed so as to be usable on that computer.

### 2-10. Processing Blocks

Note that the block diagram used in the description of the above embodiment shows blocks of functional units. These function blocks (constituent units) are realized by any combination of at least one of hardware and software. The method of realizing each function block is not particularly limited.

That is, each functional block may be realized by using one device physically or logically coupled, or may be realized by directly or indirectly connecting two or more devices that are physically or logically separated (using, for example, a wired connection, a wireless connection, or the like), and using the plurality of these devices. Function blocks may also be realized by combining the one device or the plurality of devices with software.

Examples of functions include determining, deciding, summing, calculating, processing, deriving, surveying, searching, confirming, receiving, transmitting, outputting, accessing, solving, selecting, setting, establishing, comparing, assuming, expecting, considering, broadcasting, notifying, communicating, forwarding, configuring, reconfiguring, allocating, mapping, assigning, and the like, but these are not limitations. For example, a functional block (constituent unit) that causes transmission to function is called a transmission unit or a transmitter (transmitter). In any case, as described above, the method of realizing a function is not particularly limited.

### 2-11. Input/Output Direction

Information and the like (see the item of “Information and Signals”) can be output from the upper layer (or lower layer) to the lower layer (or upper layer). Input/output may be performed via a plurality of network nodes.

### 2-12. Handling of Input/Output Information and the Like

Information and the like that has been input/output may be saved in a specific location (for example, a memory), or may be managed using a management table. The information and the like that is input/output can be overwritten, updated, or added to. Information and the like that has been output may be deleted. Information and the like that has been input may be transmitted to another device.

### 2-13. Determination Method

Determination may be performed according to a value (0 or 1) represented by 1 bit, or may be performed according to a Boolean value (Boolean: true or false), or may be performed by comparing numerical values (for example, comparison with a predetermined value).

### 2-14. Processing Sequences and the Like

The processing sequences, procedures, flowcharts, and the like of the embodiments described in this disclosure may be carried out in different orders as long as doing so does not create conflict. For example, in the methods described in the present disclosure, the elements of a variety of steps are presented in an order given as an example, and the order is not limited to the specific order presented here.

### 2-15. Handling of Input/Output Information and the Like

Information and the like that has been input/output may be saved in a specific location (for example, a memory), or may be managed using a management table. The information and the like that is input/output can be overwritten, updated, or added to. Information and the like that has been output may be deleted. Information and the like that has been input may be transmitted to another device.

### 2-16. Software

Regardless of whether software is referred to as software, firmware, middleware, microcode, hardware description language, or by another name, “software” should be interpreted broadly as meaning commands, command sets, code, code segments, program code, programs, sub programs, software modules, applications, software applications, software packages, routines, subroutines, objects, executable files, execution threads, sequences, functions, and the like.

Additionally, software, commands, and the like may be exchanged over a transmission medium. For example, when software is transmitted from a website, a server, or another remote source using hardwired technologies such as coaxial cable, fiber optic cable, twisted pair cabling, or digital subscriber line (DSL), and/or wireless technologies such as infrared light, radio waves, or microwaves, at least one of these hardwired technologies and wireless technologies is included in the definition of “transmission medium”.

### 2-17. Information and Signals

The information, signals, and the like described in the present disclosure may be expressed using any of a variety of different techniques. For example, data, instructions, commands, information, signals, bits, symbols, chips, and the like that may be referred to throughout all of the foregoing descriptions may be expressed by voltages, currents, electromagnetic waves, magnetic fields or magnetic particles, photo fields or photons, or any desired combination thereof.

### 2-18. Term “Determine”

The term “determine” as used in this disclosure may encompass a wide variety of actions. For example, performing any action of determining, calculating, computing, processing, deriving, investigating, looking up, searching, inquiring (for example, searching in a table, a database, or another data structure), ascertaining or the like may be considered as performing an action of “determining”.

Also, for example, performing any action of receiving (for example, receiving information), transmitting (for example, transmitting information), input, output, accessing (for example, accessing data in memory) or the like may be considered as performing an action of “determining”. Also, performing any action of resolving, selecting, choosing, establishing, comparing, or the like may be considered as performing an action of “determining”. That is, performing some action may be considered as performing an action of “determining”. Also, the term “determining” may be replaced with “assuming”, “expecting”, “considering”, or the like.

### 2-19. Meaning of “Based On”

The phrase “based on” used in the present disclosure does not mean “based only on” unless specifically mentioned. In other words, the phrase “based on” means both “based only on” and “based at least on”.

### 2-20. Term “Different”

In the present disclosure, the phrase “A and B are different” may mean “A and B are different from each other”. This phrase may mean that “A and B are each different from C”. Terms such as “away” and “coupled” may be construed in a similar manner as “different”.

### 2-21. Terms “And” and “Or”

In the present disclosure, with respect to configurations that can be realized both as “A and B” and “A or B”, a configuration described using one of these phrases may be used as a configuration described by the other of these phrases. For example, if the phrase “A and B” is used, “A or B” may be used as long as implementation is possible without conflicting with the other phrase.

### 2-22. Variations and the Like of Embodiments

The embodiments described in the present disclosure may be used alone, may be combined, or may be switched according to how the invention is to be carried out. Additionally, notifications of predetermined information (for example, a notification that “X is true”) are not limited to explicit notifications, and may be carried out implicitly (for example, the notification of the predetermined information is not carried out).

Although the foregoing has described the present disclosure in detail, it will be clear to one skilled in the art that the present disclosure is not intended to be limited to the embodiments described in the present disclosure. The present disclosure can be carried out in modified and altered forms without departing from the gist and scope of the present disclosure set forth in the appended scope of patent claims. As such, the descriptions in the present disclosure are provided for illustrative purposes only, and are not intended to limit the present disclosure in any way.

### REFERENCE SIGNS LIST

1 . . . Operation management support system

10 . . . Server

20 . . . Drone

30 . . . Integrated management device

101 . . . Flight plan transmission unit

102 . . . Flight information acquisition unit

103 . . . Flight irregularity determination unit

104 . . . Flight plan acquisition unit

105 . . . First collision specification unit

106 . . . Avoidance processing unit

107 . . . Flight irregularity notification unit

108 . . . Irregularity notification receiving unit

109 . . . Second collision specification unit

110 . . . Collision notification unit

111 . . . Collision notification receiving unit

201 . . . Flight control unit

202 . . . Flight information transmission unit

301 . . . Flight plan acquisition unit

302 . . . Flight plan storage unit

303 . . . Flight plan distribution unit

What is claimed is:

1.-9. (canceled)

10. An information processing apparatus comprising:
a plan acquisition unit configured to acquire flight plans for an aerial vehicle belonging to a first group;
a status acquisition unit configured to acquire a flight status of the aerial vehicle; and
a notification unit configured to notify a flight status to an external device associated with an aerial vehicle belonging to a second group, when the flight status of the aerial vehicle indicative of deviation from the acquired flight plan is acquired.

11. The information processing apparatus according to claim 10, wherein:
a plurality of groups to which an aerial vehicle belong different from the first group are provided;
the plan acquisition unit further acquires a flight plan for an aerial vehicle belonging to a group other than the first group;
a first specification unit is further provided that specifies when a flight status indicative of the deviation from the flight plan is acquired, based on the acquired flight plans for an aerial vehicle belonging to another group different from the first group, an aerial vehicle at risk of collision with the aerial vehicle having the flight status; and
the notification unit notifies a group to which the specified aerial vehicle at risk of collision belongs as the second group.

12. The information processing apparatus according to claim 11,
wherein a position of the aerial vehicle is included in the flight status of the aerial vehicle, and
the first specification unit specifies the aerial vehicle at risk of collision based on a distance between a position of the aerial vehicle included in the acquired flight status indicative of deviation from the acquired flight plan, and a position of the aerial vehicle belonging to the other group, the position being described in the acquired flight plan.

13. The information processing apparatus according to claim 11,
wherein information on an airspace in which an aerial vehicle is flying is included in the flight status of the aerial vehicle, and
the first specification unit, when a flight status of an aerial vehicle indicative of deviation from the flight plan is acquired, determines an aerial vehicle for which a flight plan has been acquired to fly in an airspace having a predetermined relationship with the airspace in which the aerial vehicle performing deviated flight is flying as the aerial vehicle at risk of collision.

14. The information processing apparatus according to claim 11, further comprising:
a processing unit that when an aerial vehicle belonging to the first group at risk of collision with another aerial vehicle, performs processing to avoid the collision, wherein
when notification of the flight status of an aerial vehicle at risk of collision with an aerial vehicle belonging to the first group is received from the external device, the processing unit performs the processing even if the aerial vehicle at risk of collision is not determined by the first specification unit.

15. The information processing apparatus according to claim 10, further comprising:
a second specification unit that, when notification of a flight status indicative of deviation from the flight plan for an aerial vehicle belonging to the second group is received from the external device, determines an aerial vehicle at risk of collision with the aerial vehicle and belongs to the first group,
wherein the notification unit notifies the flight status of the aerial vehicle specified by the second specification unit to the external device.

16. The information processing apparatus according to claim 15,
wherein a position of the aerial vehicle is included in the flight status of the aerial vehicle, and
the second specification unit determines the aerial vehicle at risk of collision based on a distance between a position of the aerial vehicle for which a flight status indicative of deviation from the flight plan is notified, and a position of the aerial vehicle belonging to the first group, the position being described in the acquired flight plan.

17. The information processing apparatus according to claim 15,
wherein information on an airspace in which an aerial vehicle is flying is included in the flight status of the aerial vehicle, and
the second specification unit, when a flight status of an aerial vehicle indicative of deviation from the flight plan and belonging to the second group is notified, determines an aerial vehicle for which a flight plan is acquired to fly in an airspace having a predetermined relationship with the airspace in which the aerial vehicle performing deviated flight is flying and belonging to the first group as the aerial vehicle at risk of collision.

18. The information processing apparatus according to claim 11,
wherein the notification unit, in a case where a plurality of aerial vehicles at risk of collision are determined, performs the notification by giving priority to an external device associated with an aerial vehicle at a higher risk of collision.
